(19) United States
(12) Patent Application Publication
(10) Pub. No.: US 2003/0070256 A1
(43) Pub. Date: Apr. 17, 2003

(54) Apparatus and method for limiting closing of a door

(76) Inventor: Daniel Kuwica, Port Moody (CA)

Correspondence Address: Charles H. DeVoe, Kolisch, Hartwell, Dickinson, McCormack & Heuser, 200 Pacific Building, 520 S.W. Yamhill Street, Portland, OR, 97204, US

(21) Appl. No.: 09/978,444

(22) Filed: Oct. 16, 2001

(51) Int. Cl. E05F 5/02

(52) U.S. Cl. 16/82

(57) ABSTRACT

An apparatus and method for spacing a door from an associated doorjamb are disclosed. The apparatus includes a spacer for limiting closing of the door such that an outer edge of the door is spaced apart from an associated doorjamb. The apparatus also includes a device cooperating with an opening in the doorjamb for securing the spacer to the doorjamb. The device may include a pair of opposing engagement members and a moveable expander for moving the engagement members into contact with an inner surface of the opening of the doorjamb. The expander may include camming surfaces which bear upon the engagement members to expand the engagement members. The method involves actuating an actuator to move the engagement members into contact with an inner surface of the opening of the doorjamb to secure the spacer to the doorjamb to limit closing of the door such that an outer edge of the door is spaced apart from the doorjamb.

### BACKGROUND OF THE INVENTION

1. Field of Invention

This invention relates to apparatus and methods for limiting closing of a swing door, and in particular, to a detachable spacer apparatus and method for spacing the door from an associated doorjamb.

2. Description of Related Art

Curiosity can drive children into situations that are beyond their capabilities to handle. A child's fingers are driven by curiosity and constantly employed to explore the world around them. As a result, there are many child safety devices that limit the ability of a child to harm him or herself. However, there are very few devices specifically tailored to limit the likelihood of a door being shut and locked inadvertently, or that limit the likelihood that a child's fingers become caught between a door and an associated doorjamb. While the former can be a minor inconvenience, the later can lead to serious injury to a child's fragile fingers.

In addition, it is common and cost-effective to keep doors open to allow air circulation to cool and/or freshen rooms in a house or building. However, breezes, wind, and/or atmospheric pressure differentials often cause inadvertent closing of doors in doorways, limiting airflow between rooms.

Typically, usually makeshift devices have been employed to block doors, such as doorstops attached to or placed in front of the door to prevent closure. However, doorstops can be easily moved or disconnected from the ground and/or the door, releasing the door.

What is desired therefore is an apparatus that overcomes these problems.

### SUMMARY OF THE INVENTION

The present invention addresses the above needs by providing an apparatus and method of limiting closing of a door.

In accordance with one aspect of the invention there is provided a detachable spacer apparatus for spacing a door from an associated doorjamb. The apparatus includes a spacer for limiting closing of the door such that an outer 10 edge of the door is spaced apart from the doorjamb, and means cooperating with an opening in the doorjamb for securing the spacer to the doorjamb.

The spacer may have an outer surface operable to contact the outer edge of the door when the spacer is secured to the doorjamb, and may further include an impact absorber. The spacer may be formed from a resilient material and arranged to absorb impact from the door, and may further include a bumper connected to the outer surface of the spacer to absorb impact from the door. The spacer may further be operable to contact the outer edge of the door at an elevation approximately the same as the elevation of the opening of the doorjamb.

The means for securing the spacer to the doorjamb may be operable to releasably secure the spacer in an opening of the doorjamb, and may include an engager for engaging the opening in the doorjamb. The engager may include a pair of opposing engagement members. The means may include means for moving the engagement members into contact with an inner surface of the opening of the doorjamb.

The means for moving may include a moveable expander for expanding the opposing engagement members. The expander may include camming surfaces which bear upon the engagement members to expand the engagement members into and out of contact with the inner surface of the opening in the doorjamb.

The means for moving may further include an actuator operable to move the expander relative to the engagement members to selectively place the engagement members in an engaged position and an unengaged position.

In accordance with another aspect of the invention there is provided another detachable spacer apparatus for spacing a door from an associated doorjamb. The apparatus includes means for limiting closing of the door such that an outer edge of the door is spaced apart from the doorjamb, and means cooperating with an opening in the doorjamb for securing the means for limiting to the doorjamb.

In accordance with another aspect of the invention there is provided another detachable spacer apparatus for spacing a door from an associated doorjamb. The apparatus includes a spacer having an outer surface operable to contact an outer edge of the door such that the outer edge of the door is spaced apart from the doorjamb, and a pair of opposing engagement members insertable into an opening of the doorjamb to secure the spacer to the doorjamb.

In accordance with another aspect of the invention there is provided a detachable spacer apparatus for spacing a door from an associated doorjamb. The apparatus includes a spacer shaped to have an outer surface operable to contact an outer edge of the door such that the outer edge of the door is spaced apart from the doorjamb. The apparatus may further include a pair of opposing engagement members insertable into an opening of the doorjamb to secure the spacer to the doorjamb, and means for moving the engagement members into contact with an inner surface of the opening of the doorjamb.

In accordance with another aspect of the invention there is provided an apparatus for blocking a door. The apparatus includes a doorjamb portion, a spacer for limiting closing of the door such that an outer edge of the door is spaced apart from the doorjamb portion, and means cooperating with an opening in the doorjamb portion for securing the spacer to the doorjamb portion.

In accordance with another aspect of the invention there is provided a method of spacing a door from an associated doorjamb. The method involves actuating an actuator to engage a device with an opening in the doorjamb to secure a spacer connected to the device to a doorjamb to limit closing of the door such that an outer edge of the door is spaced apart from the doorjamb.

The method may involve releasably securing the spacer to the doorjamb, and may further involve inserting a pair of opposing engagement members into the opening of the doorjamb.

The method may further involve moving the engagement members into contact with an inner surface of the opening of the doorjamb, and moving an expander relative to the engagement members to selectively place the engagement members in an engaged position, in which the engagement members engage the inner surface of the opening of the doorjamb, and an unengaged position, in which the engagement members are released from the opening of the doorjamb.

The apparatus described herein is inexpensive to produce and useful to prevent serious injury to a child's fingers. The apparatus is unobtrusive, and all parts are preferably rounded and coated with a soft coating such as vinyl or rubber to prevent injury. A child's hand on the doorknob of the door in the act of closing the door will not touch the apparatus when installed into the doorjamb.

The apparatus of the present invention finds particular application in daycare centres and play schools where children are apt to close the door on their own or others' fingers. It is also useful in senior homes where nurses may not wish a door to be completely closed.

The apparatus also reduces the likelihood that children or others will lock themselves in a room that has a mechanical locking mechanism in a door knob assembly or a dead bolt, by limiting the complete closure of the door.

### BRIEF DESCRIPTION OF THE DRAWINGS

In drawings which illustrate embodiments of the invention,

FIG. 1 is a cross-sectional view taken horizontally through a door and an associated doorjamb, of a system for limiting the closing of the door, according to a first embodiment of the invention.

FIG. 2 is an exploded side view of a detachable spacer apparatus of the system shown in FIG. 1.

FIG. 3 is a perspective view of the detachable spacer apparatus shown in an unengaged position.

FIG. 4 is a perspective view of the detachable spacer apparatus shown in an engaged position.

FIG. 5 is a side view of a second embodiment of the apparatus of the present invention formed from plastic.

FIG. 6 is front view of the space apparatus of the second embodiment.

FIG. 7 is an end view of the space apparatus of the second embodiment.

### DETAILED DESCRIPTION

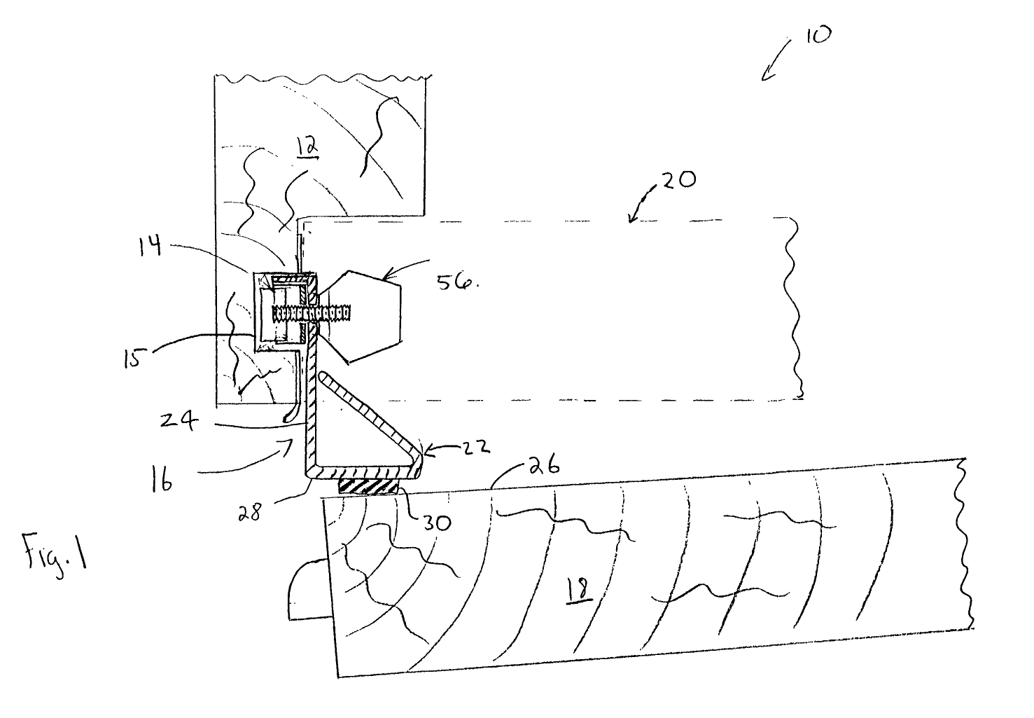

Referring to FIG. 1, a system for limiting the closing of a door, according to one aspect of the invention is shown generally at 10. The system 10 includes a doorjamb portion 12 and a detachable spacer apparatus 16 according to another aspect of the invention, operable to limit the closing of a door 18. The detachable spacer apparatus 16 may cooperate with the doorjamb 12 such that it is secured thereto and this may be effected by cooperating with an opening 14, such as a strike hole in the doorjamb. Alternatively the detachable spacer apparatus 16 may cooperate with other openings in the doorjamb portion 12, for example. Use of the detachable spacer apparatus 16 described herein allows the door 18 to be freely opened to allow traffic to move between rooms without restricting access to the rooms by, for example, limiting movement of the door to a fixed location spaced apart from the doorjamb. Moreover, the detachable spacer apparatus 16 may be used in doorways to allow airflow between rooms by limiting the inadvertent closing of the door 18 due to breezes, wind, and/or atmospheric pressure differentials.

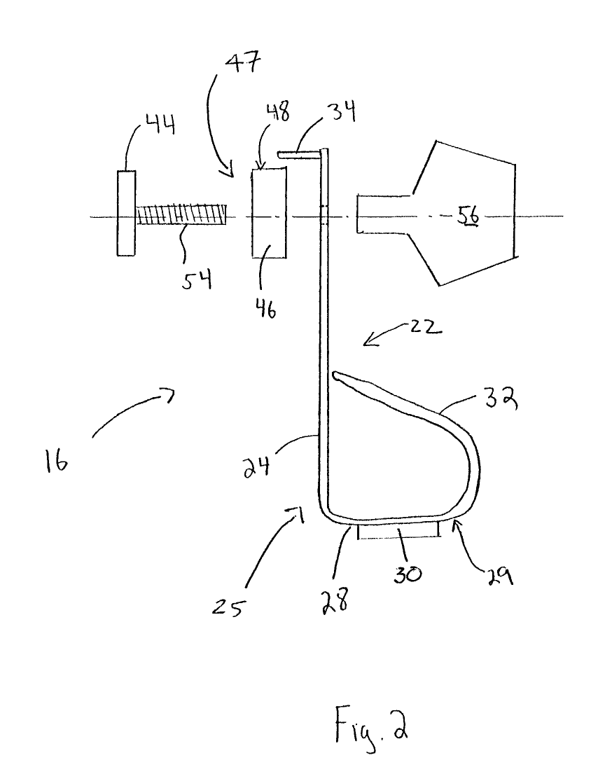

Referring to FIGS. 2-4, the detachable spacer apparatus 16 according to a first embodiment is shown separately from the doorjamb portion 12 in various views. In this embodiment the detachable spacer apparatus 16 includes a spacer 22, and a device for cooperating with an opening in the doorjamb to secure the spacer to the doorjamb.

In this embodiment, the spacer 22 is formed from sheet material bent into the shape shown in FIG. 2. The sheet material is preferably steel coating with a soft coating such as rubber or vinyl to avoid sharp edges. Alternatively, the sheet material may be any other material, such as aluminum, brass, or plastic for example, with sufficient strength to avoid breakage when struck by the door 18. The spacer 22 in this embodiment includes a flat, elongated face portion 24 operable to face the doorjamb portion 12 when the apparatus is attached to the doorjamb portion. The apparatus further includes an impact absorbing portion 25. In this embodiment, the impact absorbing portion 25 is formed from an outer portion 29 of the sheet material which has been bent to form a generally right angle with the face portion 24. The outer portion 29 has an outer surface 28 which faces outwardly from the outer portion 29 toward an outer edge 26 of the door 18 when the door is near its closed position (shown in broken outline 20 in FIG. 1). The impact absorbing portion 25 further includes a rear portion 32 formed in the sheet material by a further bend on the outer portion 29, so that the rear portion extends at an angle to the outer portion and to the face portion 24. The bend between the face portion 24 and the outer portion 29 causes the outer portion to be resiliently flexible to absorb impact forces imposed by the door 18 striking the outer portion of the spacer 22. The rear portion 32 is dimensioned to contact the face portion 24 when excessive force is received at the outer portion 29 sufficient to bend the outer portion. If the sheet material is sufficiently resilient to absorb impact forces, the rear portion 32 may not be necessary.

The spacer 22 in this embodiment also includes a guide portion 34, extending at right angles to the face portion 24, in a direction opposite the outer portion 29, for aligning the spacer against the inner surface 15 of the strike hole 14 in the doorjamb portion 12. In this embodiment, each of the bends in the spacer 22 have smooth rounded edges to limit injury to a child's fingers or to avoid catching pieces clothing, for example.

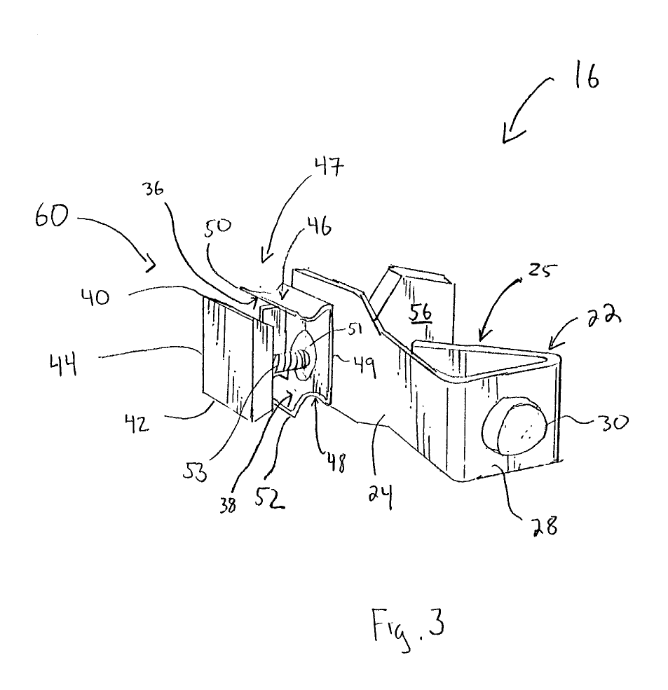

In this embodiment, impact forces on the outer portion 29 are further absorbed by a bumper 30 connected to the outer surface 28 of the spacer 22. The bumper 30 in this embodiment is formed from a resilient elastomer operable to resist compressive forces. The bumper 30 is preferably glued onto the outer surface 28 of the outer portion 29 of the spacer 22. Alternatively, bumper 30 may be mounted to outer surface 28 via an extension received in an opening through outer surface 28. Still referring to FIGS. 2-4, the device for cooperating with the opening in the doorjamb includes an engager 47. Referring to FIG. 3, the engager 47 includes engagement members 46 and 48 and an intermediate portion 49 therebetween. In this embodiment, the engager 47 is formed from a length of spring steel with each engagement member 46 and 48 being formed at opposite ends thereof. The engagement members 46 and 48 are formed at generally right angles to the intermediate portion 49 to extend generally parallel to each other. Each engagement member 46 and 48 has bent distal ends 50 and 52, forming respective convexly curved inner surfaces 36 and 38 thereon. The engager is made from a material that permits the engagement members 46 and 48 to be resiliently bendable. The bent ends 50 and 52 of the engagement members 46 and 48 are shaped to engage the inner surface 15 of the strike hole 14 to limit movement of the spacer 22 in the strike hole. In alternative embodiments to the one shown in FIG. 3, the engagement members 46 and 48 may be shaped in other manners such that they are operable to engage the inner surface 15 of the strike hole 14 of the doorjamb portion 12.

The intermediate portion 49 of the engager has an opening 51 and the face portion 24 of the spacer 22 has an opening (not shown) of approximately the same size. An expander 44 operable to expand the engagement members 46 and 48 is fixedly secured to a threaded shaft 53 which is arranged to extend through the openings with the head on a side of the face portion 24 opposite the engager 47.

The expander 44 in this embodiment is formed from solid steel and has angled camming surfaces 40 and 42 which are operable to bear upon respective curved inner surfaces 36 and 38 of the engagement members 46 and 48 when the threaded shaft 53 is drawn through the openings in the engager 47 and the face portion 24 such that the expander is moved toward the face portion, to outwardly expand the engagement members to move them away from each other. An actuator, in the form of a wing nut 56 is threadedly engaged with the portion of the threaded shaft 53 which extends on a side of the face portion 24 opposite the engager 47 to allow a user to draw the threaded shaft through the openings by rotation thereof. Rotation of the wing nut 56 causes the expander 44 to be moved toward the face portion 24 to contact the engagement members 46 and 48, and forces the bent ends 50 and 52 of the engagement members to engage the inner surface 15 of the strike hole 14 of the doorjamb portion 12 to secure the detachable spacer apparatus 16 thereto.

Referring to FIGS. 3 and 4, effectively the actuator 56 is operable to move the expander 44 relative to the engagement members 46 and 48 to selectively place the engagement members in an unengaged position, shown at 60 in FIG. 3, in which the detachable spacer apparatus 16 is releasable from the opening 14 of the doorjamb portion 12, and to place the engagement members in an engaged position, shown at 70 in FIG. 4, in which the detachable spacer apparatus is secured to the opening in the doorjamb portion.

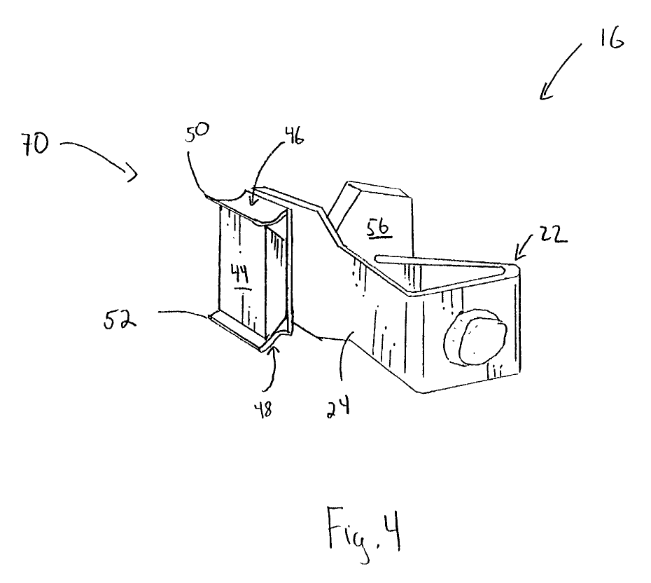

FIGS. 5 to 7 show a second embodiment of the detachable spacer apparatus 116 according to the present invention. As in the previous embodiment, spacer apparatus 116 is formed from a spacer and a device for cooperating with an opening in the doorjamb to secure the spacer to the doorjamb. In the second embodiment, spacer 122 is formed as a unitary resilient member. Preferably, spacer 122 is moulded from hard plastic, however, other resilient materials will be apparent to a person skilled in the art.

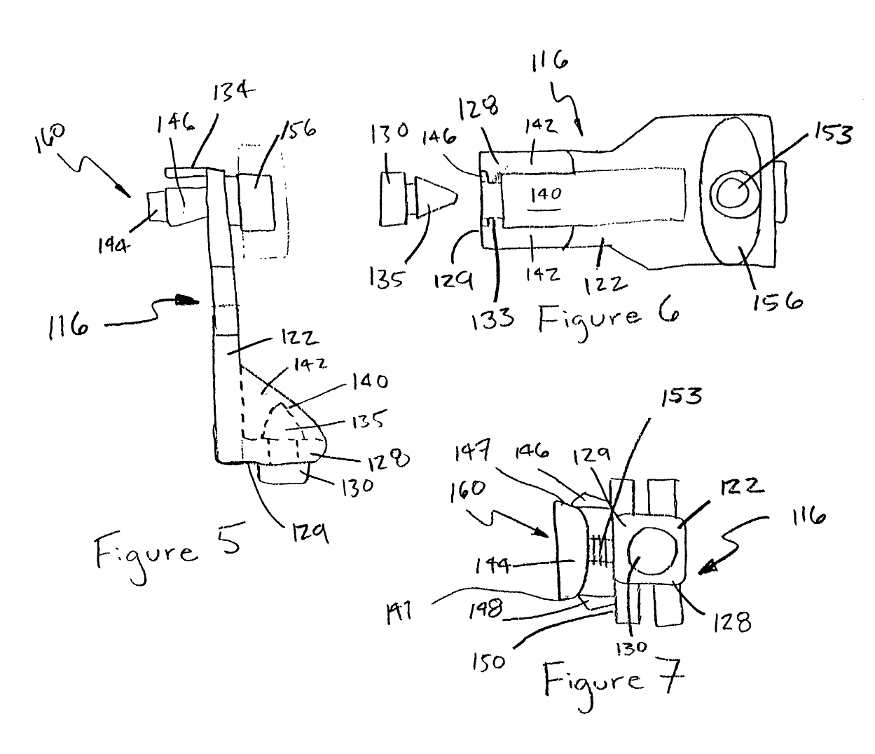

Spacer 122 comprises an elongate main body having first and second ends. The first end of spacer 122 is moulded into a flange 128 that extends at substantially a right angle to the main body. Flange 128 has an outer surface 129 adapted to mounted a bumper 130. Flange 128 replaces the folded sheet material structure 28, 29 and 32 of the first embodiment. As best shown in FIG. 6, bumper 130 is mounted to flange 128 via an opening 133 through the flange to position the bumper to engage a door. Bumper 130 is preferably formed from rubber and includes a conical insert 135 adapted to be inserted through opening 133 in one direction to lock the bumper in place on outer surface 129. Conical insert 135 is received in a cavity 140 defined by generally triangular upper and lower bracing surfaces 142 extending between flange 128 and the main body of spacer 122. Conical insert 135 and cavity 140 make it difficult for children's fingers to pry the bumper loose from the apparatus, otherwise bumper 130 might present a choking hazard for very small children. As best shown in FIG. 6, opening 133 in flange 128 is preferably formed with a recessed shoulder 146 SO that only a portion of bumper 130 is exposed to further deter children from prying the bumper from flange 128. In addition, as a further precaution, glue can be used to locate bumper 130 to the recessed shoulder to prevent removal.

In the present embodiment, bumper 130, flange 128 and upper and lower bracing surfaces 142 act to absorb the impact of a closing door. Bumper 130 presents a resilient, readily deformable surface that initially engages the door to avoid damaging or marking the door surface.

At the second end of spacer 122, there is formed a device for cooperating with an opening in the doorjamb to secure the spacer to the doorjamb. The second end of the elongate body is wider than the first end to strengthen the second end for engagement with the doorjamb and to provide an enlarged surface 150 for positioning the device for cooperating with the opening of a doorjamb. As best shown in FIG. 7, this device designated generally by reference number 160 includes engagement members in the form of spaced, resilient arms 146, 148 that are integrally moulded to surface 150 and extend outwardly at substantially right angles to the surface. Interposed between arms 146 and 148 is an expander 144 that is non-rotatably mounted to a threaded shaft 153. Shaft 153 extends through an opening in the main body and is received in a threaded opening in an actuator in the form of a rotatable grip 156. Preferably, expander 144 is a plastic block formed with cammed ends 147 adapted to engage arms 146 and 148. Alternatively, expander 144 may be made from steel or brass.

Rotation of grip 156 causes threaded shaft 153 to lengthen or shorten as the shaft is advanced through the threaded opening in the grip with the result that expander 144 is moved away from or toward surface 150 to vary the position of arms 146, 148. When expander 144 is moved toward surface 150, the cammed ends 147 cause arms 146 and 148 to expand outwardly to engage the inner surfaces of the hole in the doorjamb to secure the spacer apparatus. On lengthening of shaft 153, expander 144 is moved from between arms 146 and 148 and the arms return to a default position due to their natural resiliency out of engagement with the inner surfaces of the hole.

The threads on shaft 153 at the end adjacent grip 156 are destroyed to prevent removal of the grip from the shaft to avoid a swallowing hazard for children.

The second end of the main body is also formed with a flange 134 that acts as a guide to assist in insertion of the expander 144 and arms 146, 148 into the hole in the doorjamb. Flange 134 also acts to absorb or spread the impact of a door engaging with the apparatus of the present invention.

Operation

Use of the apparatus of the present invention is straightforward and requires no tools.

Referring to FIGS. 1, 3, and 4, installing the detachable spacer apparatus 16 of the first embodiment into a doorjamb portion 12, if the engagement members 46 and 48 are not already in the unengaged position 60, involves moving the members into the unengaged position by loosening the wing nut 56 to permit the expander 44 to move away from the face portion 24 of the spacer 22 due to resilience forces on the engagement members 46 and 48 tending to close the engagement member toward each other due to the resilience of the engager 47. The engagement members 46 and 48 are then inserted into the opening 14 of the doorjamb portion 12. The wing nut 56 is then tightened to move the expander 44 toward the face portion 24 to expand the engagement members 46 and 48 to the engaged position 70 to engage the inner surface 15 of the opening 14 of the doorjamb portion 12. As seen in FIG. 1, when secured to the opening 14 in the doorjamb portion 12, the detachable spacer apparatus 16 limits the closing of the door 18 such that the outer edge 26 of the door is spaced apart from the doorjamb portion and prevents the door from being placed in the closed position 20. The spacer 22 is thus secured to the doorjamb portion 12 to limit closing of the door 18 such that the outer edge 26 of the door is spaced apart from the doorjamb portion.

Referring back to FIG. 3, loosening the wing nut 56 permits the expander 44 to move away from the engagement members 46 and 48 and the resilience of the engagement members causes them to return to the unengaged position 60 whereby the bent ends 50 and 52 of the engagement members are released from the inner surface 15 of the strike hole 14 so that the detachable spacer apparatus 16 may be simply removed and stored or used in another location.

The operation of the second embodiment is similar. Turning of handle 156 allows for expansion of arms 146 and 148 to releasably lock the spacer apparatus in an opening in a doorjamb to position the apparatus to prevent closure of the door.

In both embodiments, the outer surface of the spacer supporting the bumper is preferably located at a separation distance greater than about 3 centimeters from a door facing surface 13 of the doorjamb portion 12 to limit movement of the door 18 to a position at this separation distance from the doorjamb portion (FIG. 1). This reduces the likelihood of injury to a child's finger or other appendages in the event that the door is moved toward closing. In general, the spacer 22 may be dimensioned to provide any separation distance.

Besides reducing the likelihood of injury, the detachable spacer apparatus 16 may also prevent children or other persons from locking themselves in a room that has a mechanical locking mechanism in a door knob assembly or a dead bolt, for example, by preventing the complete closure of the door 18 in the closed position 20. In addition, the detachable spacer apparatus 16 may limit closing of the door 18 whereby airflow is permitted through the doorway, while the door is almost closed. This may be useful where an air pressure differential on opposite sides of the door 18 would tend to fully close the door.

The engagement members and the expander may be generally symmetrically shaped, thereby allowing the detachable spacer apparatus 16 to be placed in a variety of doorjamb portions having associated left-handed or right-handed swinging doors.

While specific embodiments of the invention have been described and illustrated, such embodiments should be considered illustrative of the invention only and not as limiting the invention as construed in accordance with the accompanying claims.

What is claimed is:

1. A detachable spacer apparatus for spacing a door from an associated doorjamb, the apparatus comprising:
a spacer for limiting closing of the door such that an outer edge of the door is spaced apart from the doorjamb; and
means operable to cooperate with an opening in the doorjamb for securing said spacer to the doorjamb.

2. The apparatus of claim 1 wherein said spacer has an outer surface operable to contact the outer edge of the door when said spacer is secured to the doorjamb.

3. The apparatus of claim 2 wherein said spacer comprises an impact absorber.

4. The apparatus of claim 2 wherein said spacer is formed from a resilient material to absorb impact from the door.

5. The apparatus of claim 4 further comprising a bumper connected to said outer surface of said spacer to absorb impact from the door.

6. The apparatus of claim 1 wherein said means is operable to releasably secure said spacer in the opening of the doorjamb.

7. The apparatus of claim 6 wherein said means comprises an engager for engaging the opening in the doorjamb.

8. The apparatus of claim 7 wherein said engager comprises a pair of opposing engagement members.

9. The apparatus of claim 8 wherein said means further comprises means for moving said engagement members into contact with an inner surface of the opening of the doorjamb.

10. The apparatus of claim 9 wherein said means for moving comprises a moveable expander for expanding said opposing engagement members.

11. The apparatus of claim 10 wherein said expander comprises camming surfaces which bear upon said engagement members to expand said engagement members into and out of contact with the inner surface of the opening of the doorjamb.

12. The apparatus of claim 11 wherein said means for moving further comprises an actuator operable to move said expander relative to said engagement members to selectively place said engagement members in an engaged position and an unengaged position.

13. The apparatus of claim 1 wherein said spacer is formed from a unitary body of resilient plastic material.

14. An detachable spacer apparatus for spacing a door from an associated doorjamb, the apparatus comprising:
means for limiting closing of the door such that an outer edge of the door is spaced apart from the doorjamb; and
means cooperating with an opening in the doorjamb for securing said means for limiting to the doorjamb.

15. A detachable spacer apparatus for spacing a door from an associated doorjamb, the apparatus comprising:
a spacer shaped to have an outer surface operable to contact an outer edge of the door such that the outer edge of the door is spaced apart from the doorjamb; and
a pair of opposing engagement members insertable into an opening of the doorjamb and engagable therewith to secure said spacer to the doorjamb.

16. A detachable spacer apparatus for spacing a door from an associated doorjamb, the apparatus comprising:
a spacer having an outer surface operable to contact an outer edge of the door such that the outer edge of the door is spaced apart from the associated doorjamb;
a pair of opposing engagement members insertable into an opening of the doorjamb and engagable therewith to secure said spacer to the doorjamb; and
means for moving said engagement members into contact with an inner surface of the opening of the doorjamb

17. An apparatus for blocking a door, the apparatus comprising:
a doorjamb portion;
a spacer for limiting closing of the door such that an outer edge of the door is spaced apart from said doorjamb portion; and
means cooperating with an opening in said doorjamb portion for securing said spacer to said doorjamb portion.

18. A method for spacing a door from an associated doorjamb, the method including
actuating an actuator to engage a device with an opening in the doorjamb to secure a spacer connected to said device to the doorjamb to limit closing of the door such that an outer edge of the door is spaced apart from the doorjamb.

19. The method of claim 18 wherein securing further comprises releasably securing said spacer to the doorjamb.

20. The method of claim 19 wherein securing comprises inserting a pair of opposing engagement members into the opening of the doorjamb.

21. The method of claim 20 wherein securing further comprises moving said engagement members into contact with an inner surface of the opening of the doorjamb.

22. The method of claim 21 wherein moving comprises moving an expander relative to said engagement members to selectively place said engagement members in an engaged position, and an unengaged position, the engaged position being a position in which said engagement members engage the inner surface of the opening of the doorjamb, and the unengaged position being a position in which said engagement members are released from the opening of the doorjamb.
